(19) United States
(12) Patent Application Publication
(10) Pub. No.: US 2025/0229737 A1
(43) Pub. Date: Jul. 17, 2025

(54) IMPACT ENERGY ABSORBING DEVICE FOR VEHICLE

(71) Applicant: AXTONE S.A., Kanczuga (PL)

(72) Inventor: Jan KUKULSKI, Kosina (PL)

(73) Assignee: AXTONE S.A., Kanczuga (PL)

(21) Appl. No.: 18/854,313

(22) PCT Filed: Apr. 3, 2023
(86) PCT No.: PCT/PL2023/050023

§ 371 Date: Oct. 4, 2024

(30) Foreign Application Priority Data
Apr. 6, 2022 (PL) P.440859

(51) Int. Cl. B60R 19/34

(52) U.S. Cl. CPC B60R 19/34

(57) ABSTRACT

An impact energy absorbing device for vehicle, comprising a cut sleeve (1) attached to the vehicle on one end and a cutting tool (2) with a circular cross-section, coaxial with the sleeve (1) and movable along the sleeve (1), whereby the cutting tool (2) has blades (3) located along the sleeve's (1) circumference, and along the length of the sleeve (1) there are furrows (4) for guiding the blades (3), whereby the furrows (4) are located on the sleeve's (1) circumference in such a manner that their location corresponds to the circumferential location of the blades (3). Wherein the cutting tool (2) is located at the sleeve's (1) free end and secured with a closing element (6) which retains the cutting tool (2) allowing it to slide along the sleeve (1) towards its end attached to the vehicle.

The present invention relates to an impact energy absorbing device for a vehicle, comprising a cut sleeve attached to the vehicle on one end, and a cutting tool with a circular cross-section, coaxial with the sleeve and movable along the sleeve, whereby the cutting tool has blades distributed along the sleeve's circumference, and along the length of the sleeve there are furrows for guiding the blades, whereby the furrows are located on the sleeve's circumference in such a manner that their location corresponds to the circumferential location of the blades.

An impact energy absorbing device has been disclosed in the patents PL202114B1 and PL211405B1, containing a rod and a cutting tool surrounding the rod. The cutting tool has at least three blades, located at the circumference of the rod in furrows, and between the blades there are guides positioning the rod.

In such devices, the energy absorption path is limited by the length of the device and the length of the space behind the device.

The purpose of this invention is to extend the energy absorption path, at the same time eliminating the disadvantages of the above solutions consisting in the need to provide space for the rod being cut inside the vehicle (in those solutions, the rod being cut gradually slides into the vehicle's interior where there is suitable space to accommodate it).

The impact energy absorbing device for vehicle according to this invention comprises a cut sleeve attached to the vehicle on one end and a cutting tool with circular cross-section, coaxial with the sleeve and movable along the sleeve. The cutting tool has blades located along the sleeve's circumference, and along the length of the sleeve there are furrows for guiding the blades, whereby the furrows are distributed on the sleeve's circumference in such a manner that their location corresponds to the circumferential location of the blades. The invention is characterized by the cutting tool being located at the sleeve's free end and secured with a closing element that retains the cutting tool, allowing it to slide along the sleeve towards its end attached to the vehicle.

Preferably, the sleeve is attached to the vehicle by means of a welded mounting plate.

Also preferably, the cutting tool is movable inside the sleeve and its blades are directed outwards.

Preferably, the sleeve is fitted with a stiffening ring around the sleeve, situated near the end of the sleeve attached to the vehicle, but at a certain distance from said end. More preferably, the stiffening ring is welded to the sleeve. Also more preferably, the stiffening ring has a triangular, rectangular or curvilinear cross-section.

Preferably, the sleeve contains at least one circumferential groove inside.

Preferably, the sleeve has a neck inside.

Preferably, the cutting tool has a flange at its free end.

Preferably, the sleeve has a circular, oval or polygonal cross-section.

Preferably, the sleeve has a rectilinear, parabolic or sinusoidal longitudinal section.

Preferably, the groove has a triangular, rectangular or curvilinear cross-section.

Preferably, the neck has a triangular, rectangular or curvilinear cross-section.

Preferably, the furrows have a triangular, rectangular or curvilinear cross-section.

Preferably, the cutting tool is at the same time a follower.

The device according to this invention operates in such manner that the cutting tool cuts off stripes of the sleeve material, weakening the material along the stripes. In extreme cases, the blades may even completely cut the sleeve into several pieces along its axis. A force resulting from an impact is applied to the tool, therefore the tools is pushed along the sleeve's axis towards the vehicle that the sleeve is attached to. Also the sleeve's free end is pushed, which results in deformation (buckling) of the remaining stripes of the sleeve's material that have not been cut, extending the path and time of absorption of energy resulting from collision.

The cut sleeve pieces may be cut and deformed in various ways and into any number of pieces. As mentioned, the cutting may comprise the entire thickness of the sleeve or its part, but deep enough for the torn pieces to be torn and deformed.

Whereby it is clear that the preferable features of the invention indicated in the dependent claims may affect device efficiency.

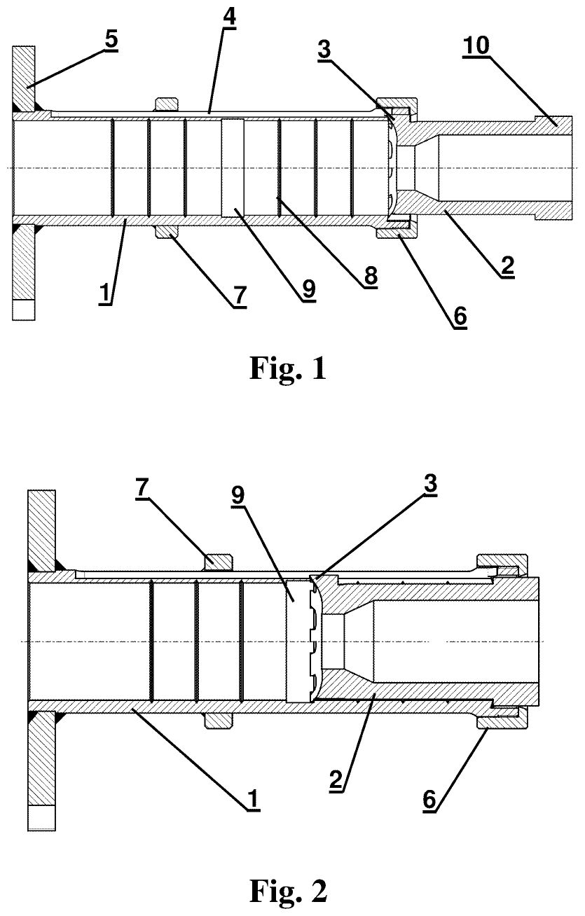

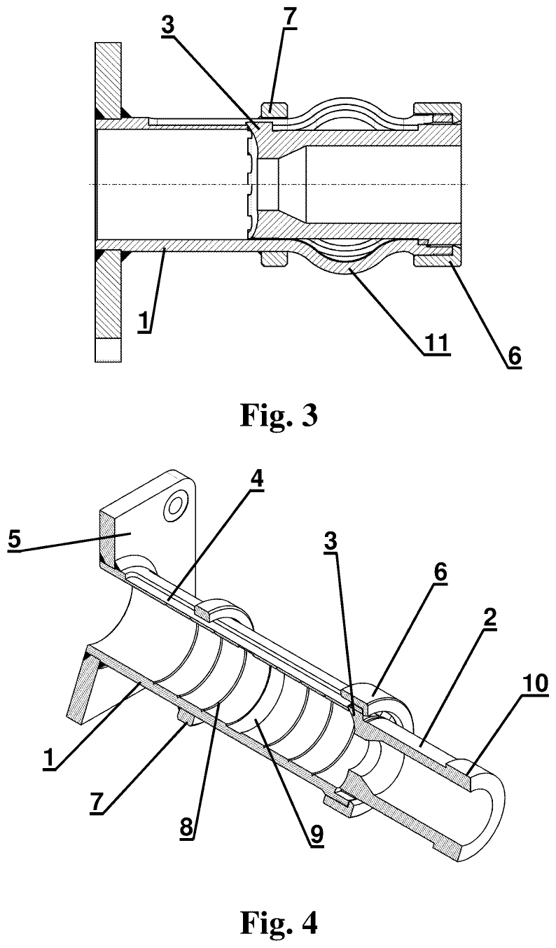

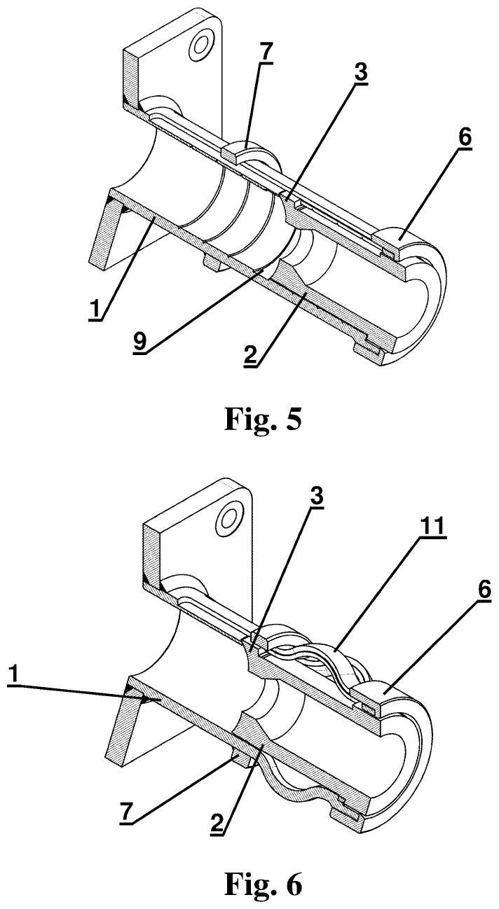

The present invention is shown in the embodiment drawings, where FIG. 1, FIG. 2 and FIG. 3 show cross-sections of the device according to the invention in the embodiment before subsequent operation phases begin, i.e. at the pre-impact phase (FIG. 1), at the cutting phase during collision but before the deformation of the remaining sleeve stripes (FIG. 2), and at the cutting phase and during the deformation of the remaining sleeve stripes (FIG. 3). FIG. 4, FIG. 5 and FIG. 6 show perspective projections of the device with its part cut away for better view of the interior, also in the same moments, respectively.

In the embodiment, the impact energy absorbing device for vehicle comprises the cut sleeve 1 attached to the vehicle on one end, and the cutting tool 2 with circular cross-section, coaxial with the sleeve 1 and movable along the sleeve 1. The cutting tool 2 is at the same time a follower and comprises blades 3 located along the circumference of the sleeve 1. The sleeve 1 has furrows 4 along its length, for guiding the blades 3. The furrows 4 are located on the sleeve's 1 circumference in such a manner that their location corresponds to the circumferential location of the blades 3. Of course, their dimension conforms to the dimension of the blades 3 so that the blades can slide freely therein. In the embodiment, the furrows 4 have a rectangular cross-section, however a person skilled in the art will know that other cross-section shapes may also be used, including triangular or curvilinear, depending on the desired device parameters.

The cutting tool 2 is located at the sleeve's 1 free end and is secured with a closing element 6 that retains the cutting tool 2, allowing it to slide along the sleeve 1 towards its end attached to the vehicle. In the embodiment, the sleeve 1 has a welded mounting plate 5 for attaching the sleeve 1 to the vehicle (not shown). However, a person skilled in the art will know that the sleeve 1 may be attached to the vehicle in any suitable manner known in the field. The cutting tool 2 is movable inside the sleeve 1 and its blades 3 are directed outwards. The number of the blades 3 may be adjusted to match the size of the sleeve and to what degree the dissipation of the energy from collision is to be retarded.

In the embodiment, the sleeve 1 has a circular cross-section and a rectilinear longitudinal section. For a person skilled in the art it will be obvious, that for different crumple parameters, different cross-section shapes may be used, e.g. the sleeve 1 can have an oval or polygonal cross-section, and the cross section can be parabolic or sinusoidal.

On the outside of the sleeve 1, the stiffening ring 7 is welded. The purpose of the ring 7 is to divide the sleeve 1 in halves, whereby during the crumple, in the part from the ring 7 to the sleeve's free end, the part of the sleeve 1 material stripes remaining after the cutting are deformed, and the part from the ring 7 to the vehicle is not deformed but rather only cut. Of course, the ring 7 is not indispensable for the device's proper operation. In the embodiment without the ring 7 (not shown), the stripes along the entire sleeve will be deformed, in a less controlled and organized manner, yet the device will also perform its role, that is energy dissipation.

The stiffening ring 7 cross-section in the embodiment is close to rectangular, but the cross-section may also have another rectangular, triangular or curvilinear shape-depending on the target parameters, which is obvious for a person skilled in the art.

Sleeve 1 has several circumferential grooves 8 inside. These are designed to break the shavings (not shown) remaining after cutting the material of the sleeve 1. The number and location of the grooves 8 may be appropriately selected, depending on the size of the device, to achieve the most efficient operation. In the embodiment, the grooves 8 are triangular in cross section, but a person skilled in the art will know also other shapes may be used, such as rectangular or curvilinear.

The sleeve 1 also has an internal neck 9. When deformation of the sleeve 1 pieces begins upon cutting, there is a temporary increase in force. The neck 9, if present, reduces the cutting force. The total force is a sum of the cutting and deformation force. Thus the neck 9 ensures a relatively stable value of the total force. In the embodiment, the neck 9 is triangular in cross section, but a person skilled in the art will know that other shapes may also be used, such as triangular or curvilinear.

In the embodiment, these elements perform an important role in the energy transfer process. Of course, the grooves 8 and the buckling 9 are not indispensable-the device will perform its function also without these elements, which will be obvious for a person skilled in the art.

The cutting tool 2 has a flange 10 at the end where the collision force is received. The flange 10 is not an indispensable element, yet it improves the distribution of forces.

The device in the embodiment above operates as described below.

Phase I (FIG. 1 and FIG. 4 Show the Device Before this Phase, i.e. Before Collision)

When a force is applied (axially or at an angle to the device's axis) to the flange 10 of the cutting tool 2, the latter begins to move axially towards the sleeve 1 end attached to the vehicle and stripes of material in the sleeve 1 are cut by the cutting tool 2 blades 3. Such cutting involves a high resistance which allows energy to be absorbed. The cutting tool 2 moves inside the sleeve 1 being cut until the flange 10 reaches the end of the sleeve 1. The internal grooves 8 are designed to break the shavings created during cutting.

Phase II (FIG. 2 and FIG. 5 Show the Device Before this Phase)

Upon contact of the cutting tool 2 flange 10 with the end of the sleeve 1 further from the vehicle, the flange 10 of the cutting tool 2, pressing the sleeve 1, causes buckling of the pieces 11 of the sleeve 1 that were created as a result of the cutting. Whereby the internal grooves 8 play an important role in reducing the peak force at buckling initiation.

During this phase, the cutting force is reduced (thanks to the neck 9 in the sleeve 1), offsetting the force resulting from buckling. This way the total force can remain at a constant level.

This phase ends when the blades 3 of the cutting tool 2 travel to the end of the neck 9.

Phase III (FIG. 3 and FIG. 6 Show the Device Before this Phase)

In this phase, the cutting tool 2 is moving further. This is possible due to further bending of the pieces 11 that remain from the sleeve 1 after cutting. The stiffening ring 7 limits the distance over which the pieces 11 of the sleeve 1 remaining after cutting are bent, which significantly increases the device's resistance to the transverse force.

Of course, the above description of operation only concerns the previously discussed embodiment, including virtually all preferable features of the device. In other embodiments, the individual phases are optional-e.g. in embodiment without the stiffening ring 7 phase III will not occur and the length over which the pieces 11 remaining after cutting are be bent will not be limited but rather the bending will occur over the entire length of the sleeve 1.

Of course, the invention is not limited to the embodiments described above, and the features indicated in the claims may be combined with each other in any combinations appropriate for a given application of the solution.

1. An impact energy absorbing device for a vehicle, comprising a cut sleeve (1) attached to the vehicle on one end, and a cutting tool (2) with a circular cross-section, coaxial with the sleeve (1) and movable along the sleeve (1), whereby the cutting tool (2) has blades (3) located along the sleeve's (1) circumference, and along the length of the sleeve (1) there are furrows (4) for guiding the blades (3), whereby the furrows (4) are located on the sleeve's (1) circumference in such a manner that their location corresponds to the circumferential location of the blades (3), characterized in that the cutting tool (2) is located at the sleeve's (1) free end and secured with a closing element (6) which retains the cutting tool (2) allowing it to slide along the sleeve (1) towards its end attached to the vehicle.

2. The device according to claim 1, wherein the sleeve (1) is attached to the vehicle by means of a welded mounting plate (5).

3. The device according to claim 1, wherein the cutting tool (2) is movable inside the sleeve (1) and its blades (3) are directed outwards.

4. The device according to claim 1 wherein the sleeve (1) is fitted with a stiffening ring (7) around the sleeve (1), situated near the end of the sleeve (1) attached to the vehicle, but at a certain distance from said end.

5. The device according to claim 4 wherein the stiffening ring (7) is welded to the sleeve (1).

6. The device according to claim 1 wherein the sleeve (1) has at least one circumferential groove (8) inside.

7. The device according to claim 1 wherein the sleeve (1) has a neck (9) inside.

8. The device according to claim 1 wherein the cutting tool (2) has a flange (10) at its free end.

9. The device according to claim 1 wherein the sleeve (1) has a circular cross-section.

10. The device according to claim 1 wherein the sleeve (1) has an oval cross-section.

11. The device according to claim 1 wherein the sleeve (1) has a polygonal cross-section.

12. The device according to claim 1 wherein the sleeve (1) has a rectilinear longitudinal section.

13. The device according to claim 1 wherein the sleeve (1) has a parabolic longitudinal section.

14. The device according to claim 1 wherein the sleeve (1) has a sinusoidal longitudinal section.

15. The device according to claim 6 wherein the groove (8) has a triangular cross-section.

16. The device according to claim 6 wherein the groove (8) has a rectangular cross-section.

17. The device according to claim 6 wherein the groove (8) has a curvilinear cross-section.

18. The device according to claim 7 wherein the neck (9) has a triangular cross-section.

19. The device according to claim 7 wherein the neck (9) has a rectangular cross-section.

20. The device according to claim 7 wherein the neck (9) has a curvilinear cross-section.

21. The device according to claim 4 wherein the stiffening ring (7) has a triangular cross-section.

22. The device according to claim 4 wherein the stiffening ring (7) has a rectangular cross-section.

23. The device according to claim 4 wherein the stiffening ring (7) has a curvilinear cross-section.

24. The device according to claim 1 wherein the furrows (4) have a triangular cross-section.

25. The device according to claim 1 wherein the furrows (4) have a rectangular cross-section.

26. The device according to claim 1 wherein the furrows (4) have a curvilinear cross-section.

27. The device according to claim 1 wherein the cutting tool (2) is at the same time the follower.
